(19) United States
(12) Patent Application Publication
(10) Pub. No.: US 2011/0170856 A1
(43) Pub. Date: Jul. 14, 2011

(54) Optical transmission device

(75) Inventors: Kenta Kannari, Kawasaki (JP); Tsuyoshi Morishita, Kawasaki (JP)

(73) Assignee: Fujitsu Optical Components Limited, Kawasaki (JP)

(21) Appl. No.: 12/929,196

(22) Filed: Jan. 6, 2011

(30) Foreign Application Priority Data
Jan. 8, 2010 (JP) 2010-003252

(51) Int. Cl. H04B 10/00

(52) U.S. Cl. 398/2

(57) ABSTRACT

An optical transmission device includes a first optical output unit including a chip and outputting an optical signal having a predetermined wavelength according to a temperature, a second optical output unit including a chip of which a temperature is controlled independently of the chip of the first optical output unit and outputting an optical signal having a predetermined wavelength according to a temperature, a failure detecting unit detecting a failure of the chip in operation of the first optical output unit, a switching unit switching its operation to the chip of the second optical output unit whose output optical signal has a same wavelength as that of the optical signal of the chip in operation of the first optical output unit when the failure detecting unit detects the failure, and a transmitting unit transmitting the optical signal output from the chip of the second optical output unit.

### CROSS-REFERENCE TO RELATED APPLICATION

This application is based upon and claims the benefit of priority of the prior Japanese Patent Application No. 2010-003252, filed on Jan. 8, 2010, the entire contents of which are incorporated herein by reference.

### FIELD

The embodiments discussed herein are directed to an optical transmission device.

### BACKGROUND

In the field of optical transmission, a wavelength division multiplexing (WDM) technology has been employed for overlapping optical signals of a plurality of different wavelengths in one optical fiber and transmitting the overlapped signals. Many optical transmission devices such as wavelength-variable laser diodes (hereinafter, “wavelength-variable LDs”) have appeared.

FIG. 13 is a diagram explaining a conventional laser diode module that mounts thereon a wavelength-variable LD. As illustrated in FIG. 13, a conventional laser diode module includes a plurality of arrayed chips (hereinafter, “array chips”). Moreover, the array chips are arranged on a Peltier thermoelectric cooler (hereinafter, “TEC”) that adjusts the temperature of the array chips. For example, the laser diode module includes an “array chip 1” to an “array chip n” that are arranged on “TEC1”. When an “array chip selector” selects “array chip 2” under the control of a central processing unit (CPU), electric currents are injected into the selected “array chip 2”. Then, the “array chip 2” outputs an optical signal having a predetermined wavelength according to the temperature that is adjusted by the “TEC1”.

FIG. 14 is a diagram explaining the wavelength-variable characteristics of array chips. In FIG. 14, a vertical axis indicates the temperature of a wavelength-variable LD, and “T_{LD}max” indicates a maximum temperature prescribed as a requirement specification of the wavelength-variable LD and “T_{LD}min” indicates a minimum temperature thereof. Moreover, a horizontal axis indicates the wavelength of an optical signal that is output from each array chip and a black circle indicates the operating point of each array chip. As illustrated in FIG. 14, the array chips have wavelength-variable characteristics different from each other. In other words, because, although each array chip outputs an optical signal having a predetermined wavelength according to a temperature, wavelength-variable characteristics of the array chips are different from each other, the array chips respectively output optical signals having different wavelengths even in the case of the same temperature.

As illustrated in FIG. 14, it is assumed, as an example, that the “array chip 2” degrades during operation and the wavelength-variable characteristic of the “array chip 2” is changed. For example, it is assumed that the wavelength-variable characteristic of the “array chip 2” illustrated with a dotted line in FIG. 14 is changed to the wavelength-variable characteristic illustrated with a solid line close to the “array chip 1”. Then, an operating point indicated with a white circle among the operating points of the “array chip 2” exceeds the maximum temperature “T_{LD}max” prescribed as the requirement specification of the wavelength-variable LD. In this case, a conventional optical transmission device detects a failure. To resolve the failure, the laser diode module is wholly exchanged, for example.

Moreover, because a solving method of wholly exchanging the laser diode module causes the increase of cost, there is a solving method of switching the operating chip from a defective array chip to another array chip of which the wavelength-variable characteristic is not changed. Specifically, the optical transmission device includes more than one array chip that outputs an optical signal having the same wavelength, and switches, when the wavelength-variable characteristic of an array chip is changed during operation, its operation from this array chip to another array chip that outputs an optical signal having the same wavelength.

For example, as illustrated in FIG. 14, the “array chip 2” and “array chip 3” each output an optical signal having the same wavelength “λn”. When the wavelength-variable characteristic of the “array chip 2” in operation is changed, the optical transmission device restarts the laser diode module and then switches from the “array chip 2” to the “array chip 3”. In this case, a temperature at which the optical signal having the wavelength “λn” is output in the “array chip 2” is different from a temperature at which the optical signal having the wavelength “λn” is output in the “array chip 3”. For this reason, when the operation is switched in a state where the temperature of the “TEC1” on which the “array chip 3” is arranged is not controlled, there is a possibility that an optical signal having a wavelength different from the wavelength “λn” is output from the “array chip 3”. Because of this, the optical transmission device restarts the laser diode module, controls the temperature of the “TEC1” in such a manner that the optical signal having the wavelength “λn” is output from the “array chip 3”, and then switches from the “array chip 2” to the “array chip 3”. This technology has been known as disclosed in, for example, Japanese Laid-open Patent Publication No. 2000-151012.

However, because the conventional art requires the restart of a laser diode module, there is a problem in that the loss of data is caused.

### SUMMARY

According to an aspect of an embodiment of the invention, an optical transmission device includes a first optical output unit that includes a chip and outputs an optical signal having a predetermined wavelength according to a temperature, a second optical output unit that includes a chip of which a temperature is controlled independently of the chip of the first optical output unit and outputs an optical signal having a predetermined wavelength according to a temperature, a failure detecting unit to detect a generation of a failure from the chip in operation of the first optical output unit, a switching unit to switch its operation to the chip of the second optical output unit to output an optical signal having a same wavelength as that of the optical signal of the chip in operation when the generation of the failure is detected by the failure detecting unit, and a transmitting unit to transmit the optical signal output from the chip of the second optical output unit by switching the operation by the switching unit.

The object and advantages of the embodiment will be realized and attained by means of the elements and combinations particularly pointed out in the claims.

It is to be understood that both the foregoing general description and the following detailed description are exemplary and explanatory and are not restrictive of the embodiment, as claimed.

### BRIEF DESCRIPTION OF DRAWINGS

FIG. 1 is a diagram explaining an optical transmission device according to a first embodiment;

FIG. 2 is a diagram explaining an optical transmission device according to a second embodiment;

FIG. 3 is a block diagram illustrating a configuration of a laser diode module according to the second embodiment;

FIG. 4 is a diagram explaining redundancy of array chips;

FIG. 5A is a diagram explaining wavelength-variable characteristics of odd-numbered array chips that are arranged on TEC_A;

FIG. 5B is a diagram explaining wavelength-variable characteristics of even-numbered array chips that are arranged on TEC_B;

FIG. 6 is a diagram illustrating a target temperature table;

FIG. 7 is a diagram explaining a temperature control according to the second embodiment;

FIG. 8 is a diagram explaining a temperature control during switching the array chips;

FIG. 9 is a diagram explaining a temperature control during switching the array chips;

FIG. 10 is a block diagram illustrating a configuration of a laser diode module according to a third embodiment;

FIG. 11 is a diagram explaining temperature control of a central part during switching of the array chips;

FIG. 12 is a diagram explaining temperature control according to the third embodiment;

FIG. 13 is a diagram explaining a conventional laser diode module that mounts thereon a wavelength-variable LD; and

FIG. 14 is a diagram explaining the wavelength-variable characteristics of array chips.

### DESCRIPTION OF EMBODIMENT(S)

Preferred embodiments of the present invention will be explained with reference to accompanying drawings. The present invention is not limited to the embodiments explained below.

### [a] First Embodiment

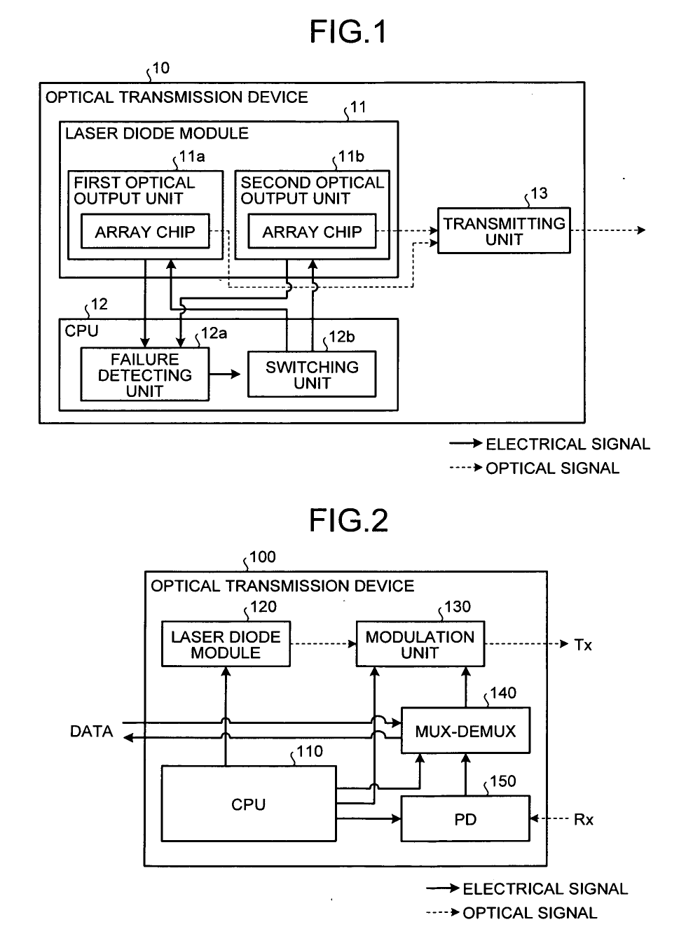

An optical transmission device 10 according to the first embodiment will be described with reference to FIG. 1. FIG. 1 is a diagram depicting the optical transmission device 10 according to the first embodiment. As illustrated in FIG. 1, the optical transmission device 10 according to the first embodiment includes a laser diode module 11, a CPU 12, and a transmitting unit 13. Moreover, in FIG. 1, a solid-line arrow indicates an electrical signal and a dotted-line arrow indicates an optical signal.

As illustrated in FIG. 1, the laser diode module 11 includes a first optical output unit 11a and a second optical output unit 11b. The first optical output unit 11a has array chips and outputs an optical signal having a predetermined wavelength according to a temperature. The second optical output unit 11b has array chips of which the temperature is controlled independently of the array chips of the first optical output unit 11a and outputs an optical signal having a predetermined wavelength according to a temperature. Moreover, an array chip that can easily output an optical signal having a desired wavelength is, for example, selected as an array chip for operation. Hereinafter, it is assumed that an array chip of the first optical output unit 11a is selected in order to output an optical signal having a desired wavelength.

Moreover, as illustrated in FIG. 1, the CPU 12 includes a failure detecting unit 12a and a switching unit 12b. The failure detecting unit 12a detects the failure of the array chip in operation included in the first optical output unit 11a. When the generation of a failure is detected by the failure detecting unit 12a, the switching unit 12b switches the operating chip from the array chip in operation to another array chip that is included in the second optical output unit 11b and outputs an optical signal having the same wavelength as that of the optical signal of the array chip in operation.

As illustrated in FIG. 1, then, the transmitting unit 13 transmits the optical signal output from the array chip of the second optical output unit 11b in accordance with the switching of the operation performed by the switching unit 12b.

In this way, according to the first embodiment, the temperature of an array chip selected as an operating side and the temperature of an array chip of a waiting side are independently controlled. For this reason, when an array chip in operation has a failure, its operation can be smoothly switched to a waiting-side array chip of which the temperature is controlled to a temperature corresponding to a desired wavelength and thus the loss of data can be prevented.

### [b] Second Embodiment

Optical Transmission Device 100

Next, an optical transmission device 100 according to the second embodiment will be described with reference to FIGS. 2 to 9. FIG. 2 is a diagram explaining the optical transmission device 100 according to the second embodiment. As illustrated in FIG. 2, the optical transmission device 100 according to the second embodiment includes a CPU 110, a laser diode module 120, a modulation unit 130, and a MUX-DEMUX (multiplexer-demultiplexer) 140, and a photo diode (PD) 150. In FIG. 2, “Tx” indicates a transmitting signal and “Rx” indicates a received signal.

As illustrated in FIG. 2, the CPU 110 controls the laser diode module 120, the modulation unit 130, the MUX-DEMUX 140, and the photo diode 150. The laser diode module 120 includes array chips (not illustrated in FIG. 2) and outputs an optical signal (continuous wave (CW) light) having a predetermined wavelength according to a temperature. Moreover, the laser diode module 120 outputs an optical signal of which the light power and wavelength are controlled by the CPU 110.

The modulation unit 130 modulates the optical signal input from the laser diode module 120 based on data input via the MUX-DEMUX 140 from the outside of the optical transmission device 100, and outputs the modulated optical signal. Moreover, because multiple pieces of data are input from the outside of the optical transmission device 100, the MUX-DEMUX 140 is serialized. Moreover, the photo diode 150 converts an optical signal received by the optical transmission device 100 into an electrical signal and outputs the converted signal to the outside of the optical transmission device 100 via the MUX-DEMUX 140. Because the electrical signal converted by the photo diode 150 is multiplexed with multiple pieces of data, the MUX-DEMUX 140 demultiplexes the multiplexed electrical signal.

Laser Diode Module 120

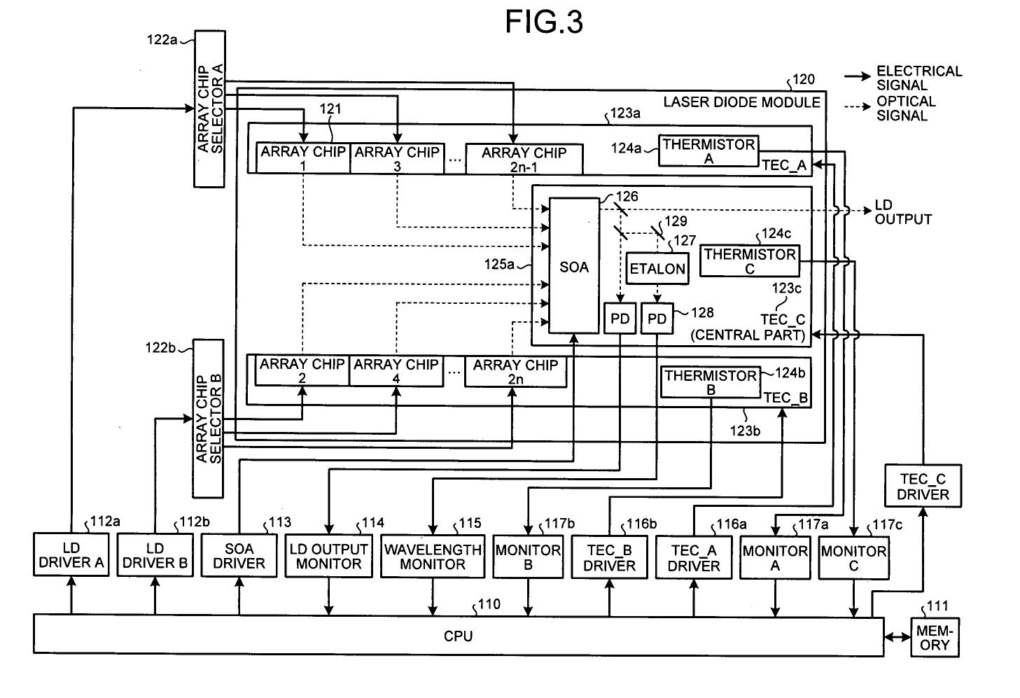

Next, the configuration of the laser diode module 120 according to the second embodiment will be described with reference to FIG. 3. FIG. 3 is a block diagram illustrating the configuration of the laser diode module 120 according to the second embodiment. As illustrated in FIG. 3, various types of drivers and various types of monitors are provided between the laser diode module 120 and the CPU 110. The laser diode module 120 transmits and receives an electrical signal to and from the CPU 110 to be controlled by the CPU 110. In FIG. 3, a solid-line arrow indicates an electrical signal and a dotted-line arrow indicates an optical signal.

As illustrated in FIG. 3, the laser diode module 120 includes a plurality of array chips 121, a TEC_A 123a and a TEC_B 123b, a thermistor A 124a and a thermistor B 124b, and a central part 125a. Moreover, the TEC_A 123a and the TEC_B 123b are respectively connected to a TEC_A driver 116a and a TEC_B driver 116b, and the thermistor A 124a and the thermistor B 124b are respectively connected to a monitor A 117a and a monitor B 117b.

The array chips 121 respectively have wavelength-variable characteristics different from each other and each output an optical signal having a predetermined wavelength according to a temperature. Specifically, when electric currents are input from an array chip selector A 122a or an array chip selector B 122b to be described below, each of the array chips 121 oscillates to output an optical signal having a predetermined wavelength according to a temperature to an SOA (Semiconductor Optical Amplifier) 126 to be described below. Moreover, the TEC_A 123a and the TEC_B 123b adjust the temperature of the array chips 121 that are arranged thereon.

As illustrated in FIG. 3, in the optical transmission device 100 according to the second embodiment, the odd-numbered array chips 121 are arranged on the TEC_A 123a and the even-numbered array chips 121 are arranged on the TEC_B 123b. In other words, the array chips 121 are alternately arranged in order of wavelengths on the two TECs, and the two TECs independently control the temperature of the array chips 121.

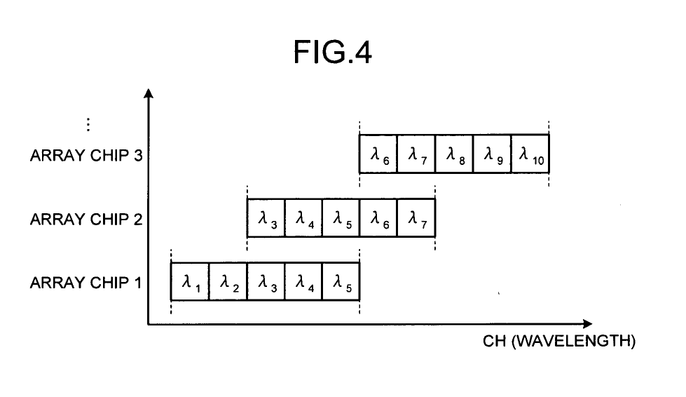

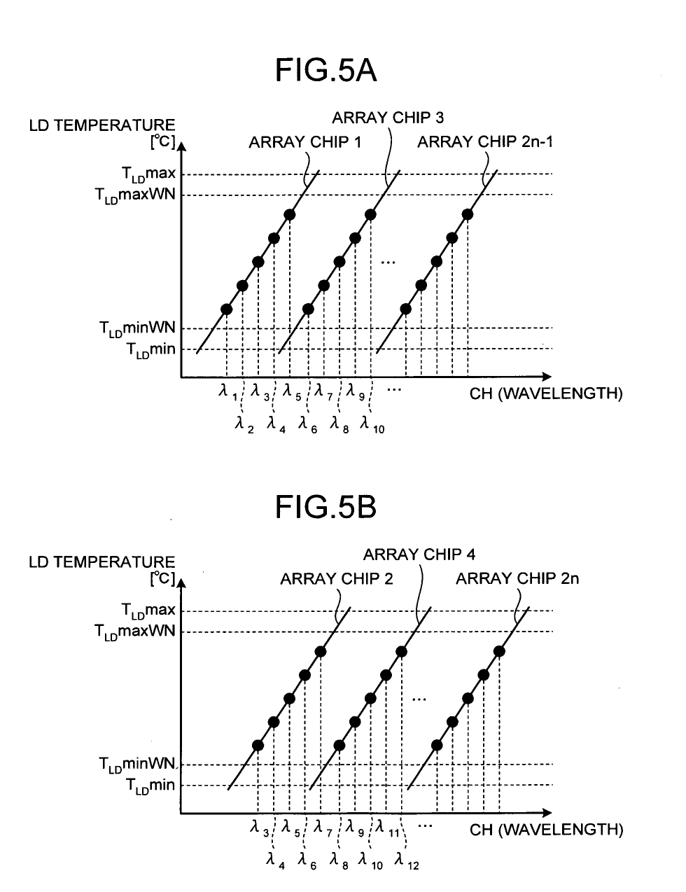

More detailed description will be given below with reference to FIGS. 4, 5A, and 5B. FIG. 4 is a diagram explaining the redundancy of the array chips 121. As illustrated in FIG. 4, in the optical transmission device 100 according to the second embodiment, operating points of each of the array chips 121 are set in such a manner that two or more array chips of the array chips 121 output an optical signal having the same wavelength, in other words, the redundant array chips 121 are provided for each predetermined wavelength.

For example, as illustrated in FIG. 4, “array chip 1” operates at wavelengths “λ1”, “λ2”, “λ3”, “λ4”, and “λ5”. Moreover, “array chip 2” operates at wavelengths “λ3”, “λ4”, “λ5”, “λ6”, and “λ7”. Thus, for the wavelengths “λ3”, “λ4”, and “λ5”, the “array chip 1” and the “array chip 2” have redundancy. Similarly, as illustrated in FIG. 4, for the wavelengths “λ6” and “λ7”, the “array chip 2” and “array chip 3” have redundancy.

However, a wavelength at which a failure easily occurs due to the degradation of the array chip 121 may be both-end wavelengths of the array chip in many cases. For example, in the case of the “array chip 2” illustrated in FIG. 4, a failure easily occurs at “λ3” and “λ7”. According to the second embodiment, the array chips 121 are not simply doubly arranged on the two TECs; instead the array chips 121 that output slightly shifted wavelengths are alternately arranged. Therefore, wavelengths at which a failure easily occurs are dispersedly arranged on the two TECs. In other words, according to the second embodiment, a wavelength at which a failure easily occurs is not replaced by the array chip 121 at which a failure easily occurs at the same wavelength.

As described above, in the optical transmission device 100 according to the second embodiment, the odd-numbered array chips 121 are arranged on the TEC_A 123a and the even-numbered array chips 121 are arranged on the TEC_B 123b. FIG. 5A is a diagram explaining the wavelength-variable characteristics of the odd-numbered array chips 121 that are arranged on the TEC_A 123a. FIG. 5B is a diagram explaining the wavelength-variable characteristics of the even-numbered array chips 121 that are arranged on the TEC_B 123b.

In FIGS. 5A and 5B, a vertical axis indicates the temperature of the laser diode module 120, “T_{LD}max” indicates a maximum temperature prescribed as the requirement specification of the laser diode module 120, and “T_{LD}min” indicates a minimum temperature thereof. Moreover, “T_{LD}maxWN” is a temperature that is slightly lower than the maximum temperature prescribed as the requirement specification of the laser diode module 120 and indicates a temperature of a warning step. Moreover, “T_{LD}minWN” is a temperature slightly higher than the minimum temperature and indicates a temperature of the warning step. Moreover, a horizontal axis indicates a wavelength of an optical signal that is output from each array chip and black circles indicate operating points of each of the array chips 121.

For example, as illustrated in FIG. 5A, the odd-numbered “array chip 1”, “array chip 3”, . . . , and “array chip 2n−1” are arranged on the TEC_A 123a. The “array chip 1” outputs an optical signal having wavelengths “λ1” to “λ5” in accordance with a temperature and the “array chip 3” outputs an optical signal having wavelengths “λ6” to “λ10” in accordance with a temperature. In this way, only the odd-numbered “array chip 1”, “array chip 3”, . . . , and “array chip 2n−1” set the operating points of the array chips 121 for all wavelengths and correspond to the operations of only the TEC_A 123a.

On the other hand, as illustrated in FIG. 5B, the even-numbered “array chip 2”, “array chip 4”, . . . , and “array chip 2n” are arranged on the TEC_B 123b. The “array chip 2” outputs an optical signal having wavelengths “λ3” to “λ7” in accordance with a temperature and the “array chip 4” outputs an optical signal having wavelengths “λ8” to “λ12” in accordance with a temperature. Moreover, the operating points for wavelengths “λ1” and “λ2” are set in the other array chip 121 not illustrated. In this way, only the even-numbered “array chip 2”, “array chip 4”, . . . and “array chip 2n” set the operating points of the array chips 121 for all wavelengths and correspond to the operations of only the TEC_B 123b.

Returning to FIG. 3, the thermistor A 124a and the thermistor B 124b respectively measure the temperatures of the TEC_A 123a and the TEC_B 123b. Specifically, the thermistor A 124a measures the temperature of the TEC_A 123a and sends the measured temperature information to the CPU 110 via the monitor A 117a to be described below. Moreover, the thermistor B 124b measures the temperature of the TEC_B 123b and sends the measured temperature information to the CPU 110 via the monitor B 117b to be described below.

As illustrated in FIG. 3, the central part 125a includes a thermistor C 124c, the SOA 126, an etalon 127, photo diodes 128, and half mirrors 129, and is arranged on a TEC_C 123c. In other words, the central part 125a according to the second embodiment is arranged on the TEC_C 123c in such a manner that the central part 125a is temperature-controlled independently of the TEC_A 123a and the TEC_B 123b and is maintained to a predetermined temperature. The thermistor C 124c measures the temperature of the central part 125a. Specifically, the thermistor C 124c measures the temperature of the central part 125a and sends the measured temperature information to the CPU 110 via a monitor C 117c to be described below.

When an optical signal is input from the array chips 121, the SOA 126 amplifies the input optical signal and outputs the amplified optical signal. The optical signal output from the SOA 126 is input into the two photo diodes 128 via the half mirrors 129. The optical signal output from the SOA 126 is directly input into the one photo diode 128 and is input into the other photo diode 128 via the etalon 127. The etalon 127 is a wavelength locker that has a periodic wavelength characteristic.

The photo diode 128 that directly receives the optical signal from the SOA 126 converts the optical signal into an electrical signal and outputs the converted signal to an LD output monitor 114 to be described below. On the other hand, the photo diode 128 that receives the optical signal via the etalon 127 converts the optical signal into an electrical signal and outputs the converted signal to a wavelength monitor 115 to be described below.

Next, it will be explained about various types of drivers and various types of monitors that are provided between the laser diode module 120 and the CPU 110. The array chip selector A 122a and the array chip selector B 122b, an LD driver A 112a and an LD driver B 112b, an SOA driver 113, the LD output monitor 114, and the wavelength monitor 115 are provided between the laser diode module 120 and the CPU 110. Furthermore, the TEC_A driver 116a, the TEC_B driver 116b, the monitor A 117a, the monitor B 117b, and the monitor C 117c are provided therebetween.

Each of the array chip selector A 122a and the array chip selector B 122b selects one from the plurality of array chips 121. Specifically, the array chip selector A 122a selects one from the plurality of array chips 121 that is arranged on the TEC_A 123a and outputs the electric current input from the LD driver A 112a to the selected array chip 121. Moreover, the array chip selector B 122b selects one from the plurality of array chips 121 that is arranged on the TEC_B 123b and outputs the electric current input from the LD driver B 112b to the selected array chip 121.

Each of the LD driver A 112a and the LD driver B 112b outputs an electric current in accordance with the control of the CPU 110. Specifically, when it is switched to an operating side by the CPU 110, the LD driver A 112a outputs an electric current to the array chip selector A 122a. On the other hand, when it is switched to a waiting side by the CPU 110, the LD driver A 112a does not output an electric current to the array chip selector A 122a. Moreover, when it is switched to an operating side by the CPU 110, the LD driver B 112b outputs an electric current to the array chip selector B 122b. On the other hand, when it is switched to a waiting side by the CPU 110, the LD driver B 112b does not output an electric current to the array chip selector B 122b.

The SOA driver 113 controls the light power of the optical signal that is output from the SOA 126. Specifically, as described above, the photo diode 128 that directly receives the optical signal from the SOA 126 converts the optical signal into an electrical signal and outputs the converted signal to the LD output monitor 114. The LD output monitor 114 monitors the output of the electrical signal output from the SOA 126 and sends the monitored light power output information to the CPU 110. Then, the CPU 110 controls the SOA driver 113 in a feedback manner on the basis of the light power output information sent from the LD output monitor 114. The SOA driver 113 controls the light power of the optical signal that is output from the SOA 126.

The TEC_A driver 116a and the TEC_B driver 116b independently control the temperatures of the TEC_A 123a and the TEC_B 123b. Specifically, as described above, the photo diode 128 that receives the optical signal from the SOA 126 via the etalon 127 converts the received optical signal into an electrical signal and outputs the converted signal to the wavelength monitor 115. The wavelength monitor 115 monitors the wavelength of the electrical signal output from the SOA 126 via the etalon 127 and sends the monitored wavelength information to the CPU 110. Then, the CPU 110 controls the TEC_A driver 116a and the TEC_B driver 116b in a feedback manner on the basis of the wavelength information sent from the wavelength monitor 115. In other words, when the wavelength information sent from the wavelength monitor 115 indicates that the wavelength does not reach a desired wavelength, the CPU 110 controls the TEC_A driver 116a and the TEC_B driver 116b to become a desired wavelength. Then, the TEC_A driver 116a and the TEC_B driver 116b respectively control the temperatures of the TEC_A 123a and the TEC_B 123b.

The monitor A 117a, the monitor B 117b, and the monitor C 117c respectively send the temperature information of the TEC_A 123a, the TEC_B 123b, and the central part 125a to the CPU 110. Specifically, the monitor A 117a sends the temperature information of the TEC_A 123a sent from the thermistor A 124a to the CPU 110. Moreover, the monitor B 117b sends the temperature information of the TEC_B 123b sent from the thermistor B 124b to the CPU 110. Furthermore, the monitor C 117c sends the temperature information of the central part 125a sent from the thermistor C 124c to the CPU 110.

Next, it will be explained about the control performed by the CPU 110. Hereinafter, it will be explained about two controls of a control during a normal operation and a control during a switching process for switching the operation of the array chips 121.

During a normal operation, the CPU 110 controls the TECs in a feedback manner in such a manner that the array chip 121 outputs an optical signal having a desired wavelength. Specifically, the CPU 110 reads a target temperature table stored in a memory 111 and specifies the array chip 121 that outputs an optical signal having a desired wavelength.

In regard to a certain wavelength, there is the array chip 121 that easily outputs the wavelength. As an example, “the array chip 121 of which the maximum power consumption for setting to the wavelength (temperature) is small” is “the array chip 121 that easily outputs the wavelength”. For this reason, when the plurality of array chips 121 can output an optical signal having a desired wavelength, the CPU 110 according to the second embodiment uniquely decides which of the array chips 121 outputs the optical signal on the basis of the maximum power consumption and specifies the array chip 121 that outputs the optical signal having the desired wavelength. Therefore, which of the TEC_A 123a and the TEC_B 123b is an operating side or a waiting-side is varied in accordance with the desirable wavelength of the optical signal to be output.

It will be further explained about a maximum power consumption. It is considered that power consumption becomes large as a difference between a setting temperature and a case temperature is large. For example, if a setting temperature is 20 degrees Celsius in a specified temperature range 0 to 70 degrees Celsius, power consumption becomes the maximum when a case temperature is 70 degrees Celsius. However, it should be considered that a power consumption slope is different between a cooling side and a heating side. In this way, because the specified temperature range is previously decided, maximum power consumption can be computed as a designed value. Hereinafter, their descriptions are omitted about the point that the array chip 121 is uniquely decided on the basis of the maximum power consumption.

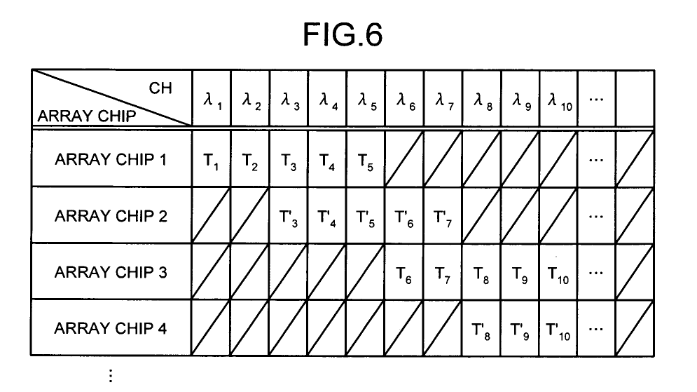

FIG. 6 is a diagram illustrating a target temperature table. As illustrated in FIG. 6, the memory 111 stores a target temperature table that is, for example, made by associating a wavelength and a target temperature for arriving at this wavelength, for each array chip. For example, the “array chip 1” corresponds to wavelengths “λ1” to “λ5” and target temperatures for the wavelengths are “T1” to “T5”. Moreover, as illustrated in FIG. 6, the memory 111 according to the second embodiment stores one target temperature table for all the array chips 121 that are arranged on the TEC_A 123a and the TEC_B 123b. However, the present invention is not limited to this. The memory 111 may store separate target temperature tables for the array chips 121 arranged on the TEC_A 123a and the array chips 121 arranged on the TEC_B 123b.

It is assumed that a desired light wavelength is, for example, “λ5”. In this case, the CPU 110 reads the target temperature table stored in the memory 111 and specifies the “array chip 1” that is the odd-numbered array chip 121 arranged on the TEC_A 123a and outputs an optical signal having the desired wavelength “λ5”. In this way, the TEC_A 123a becomes an operating side and the TEC_B 123b becomes a waiting-side. Then, the CPU 110 controls the LD driver A 112a and the array chip selector A 122a in such a manner that the “array chip 1” is selected by the array chip selector A 122a and an electric current is input into the “array chip 1” from the LD driver A 112a.

Moreover, the CPU 110 specifies the target temperature “T5” stored in association with the wavelength “λ5” of the “array chip 1” from the target temperature table and controls the TEC_A driver 116a in such a manner that the temperature of the TEC_A 123a becomes the target temperature “T5”. The temperature information of the TEC_A 123a is measured by the thermistor A 124a and is sent to the CPU 110 via the monitor A 117a. For this reason, the CPU 110 controls the TEC_A driver 116a in a feedback manner in such a manner that the temperature of the TEC_A 123a becomes the target temperature “T5”.

Moreover, when the wavelength information of the optical signal output from the “array chip 1” is received from the wavelength monitor 115, the CPU 110 determines whether the wavelength of the optical signal output from the “array chip 1” is “λ5”. Then, the CPU 110 controls the TEC_A driver 116a in a feedback manner in such a manner that the wavelength of the optical signal output from the “array chip 1” becomes “λ5”. In other words, even if the temperature of the TEC_A 123a becomes the target temperature “T5”, the wavelength of the optical signal output from the “array chip 1” may not necessarily become “λ5”. For this reason, the CPU 110 controls the TEC_A driver 116a in a feedback manner in such a manner that the wavelength of the optical signal output from the “array chip 1” becomes “λ5”.

In this way, the CPU 110 also receives the temperature information of the TEC_A 123a from the monitor A 117a while controlling the TEC_A driver 116a in a feedback manner in such a manner that the wavelength of the optical signal output from the “array chip 1” becomes “λ5”. In this case, for example, it is assumed that the “array chip 1” degrades and the wavelength-variable characteristic of the “array chip 1” is changed. For example, it is assumed that the CPU 110 receives temperature information, which exceeds the warning step “T_{LD}maxWN” of the maximum temperature prescribed as the requirement specification of the laser diode module 120, from the monitor A 117a.

Then, the CPU 110 detects the generation of a failure from the “array chip 1” in operation. Then, the CPU 110 switches its operation to the array chip 121 that outputs an optical signal having the same wavelength as that of the optical signal output from the “array chip 1” in operation and is arranged on the waiting-side TEC_B 123b.

Specifically, during a switching process for switching the operation of the array chip 121, the CPU 110 reads the target temperature table stored in the memory 111 and specifies the array chip 121 that is arranged on the waiting-side TEC and outputs an optical signal having a desired wavelength. For example, the CPU 110 reads the target temperature table stored in the memory 111 and specifies the “array chip 2” that is the even-numbered array chip 121 arranged on the waiting-side TEC_B 123b and outputs the optical signal having the desired wavelength “λ5”.

Moreover, the CPU 110 specifies a target temperature “T′5” stored in association with the wavelength “λ5” of the “array chip 2” from the target temperature table and controls the TEC_B driver 116b in such a manner that the temperature of the TEC_B 123b becomes the target temperature “T′5”. The temperature information of the TEC_B 123b is measured by the thermistor B 124b and is sent to the CPU 110 via the monitor B 117b. For this reason, the CPU 110 controls the TEC_B driver 116b in a feedback manner in such a manner that the temperature of the TEC_B 123b becomes the target temperature “T′5”.

When the wavelength information of the optical signal output from the “array chip 2” is received from the wavelength monitor 115, the CPU 110 determines whether the wavelength of the optical signal output from the “array chip 2” is “λ5”. Then, the CPU 110 controls the TEC_B driver 116b in a feedback manner in such a manner that the wavelength of the optical signal output from the “array chip 2” becomes “λ5”. In other words, even if the temperature of the TEC_B 123b becomes the target temperature “T′5”, the wavelength of the optical signal output from the “array chip 2” may not necessarily become “λ5”. For this reason, the CPU 110 controls the TEC_B driver 116b in a feedback manner in such a manner that the wavelength of the optical signal output from the “array chip 2” becomes “λ5”.

After that, when it is determined that the temperature of the TEC_B 123b is stable, the CPU 110 controls the LD driver B 112b and the array chip selector B 122b. Specifically, the CPU 110 switches its operation from the LD driver A 112a to the LD driver B 112b in such a manner that the “array chip 2” is selected by the array chip selector B 122b and an electric current is input into the “array chip 2” from the LD driver B 112b.

In addition to a technique for controlling the temperature of a waiting-side TEC after the detection of failure, the temperature of a waiting-side TEC may be previously controlled.

Temperature Control

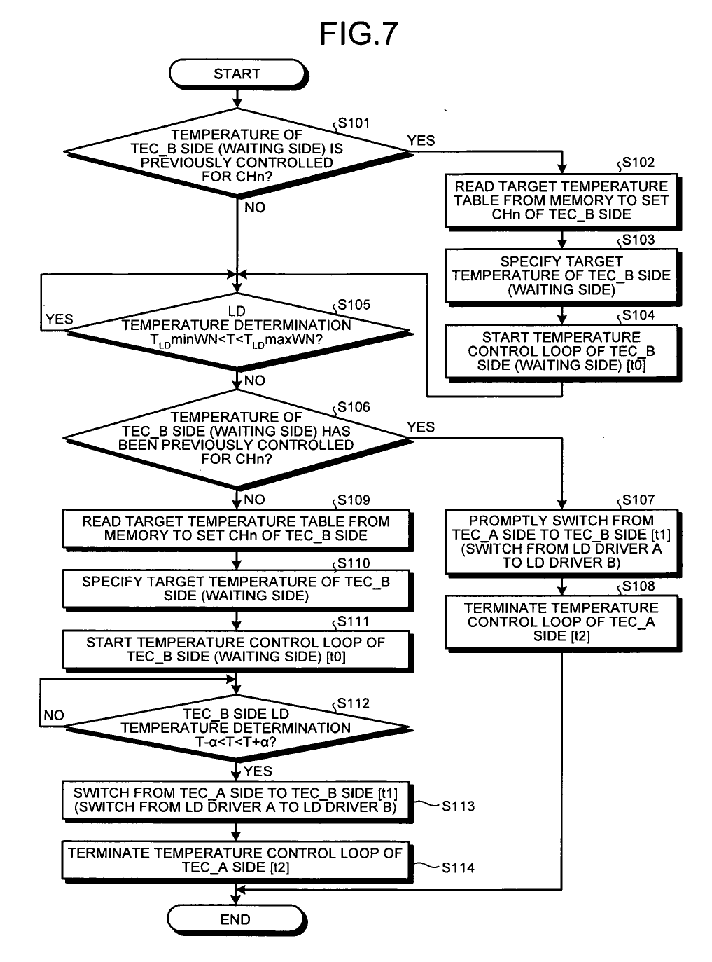

Next, it will be explained about a temperature control according to the second embodiment with reference to FIGS. 7 to 9. FIG. 7 is a diagram explaining a temperature control according to the second embodiment. Hereinafter, it will be explained about the case where the TEC_A 123a is an operating side and the TEC_B 123b is a waiting-side by uniquely specifying the array chip 121 that can easily output an optical signal having a desired wavelength. In the optical transmission device 100 according to the second embodiment, it is assumed that the CPU 110 can receive the selection of whether the temperature of a waiting-side TEC is previously controlled to a temperature corresponding to a desired wavelength, for example, from an operator of the optical transmission device 100.

As illustrated in FIG. 7, the CPU 110 determines whether the temperature of the waiting-side TEC_B 123b is previously controlled for CHn (Step S101). For example, if the wavelength of “CHn” is “λ5”, the CPU 110 determines whether the temperature of the TEC_B 123b is previously controlled to a temperature corresponding to the wavelength “λ5”.

When it is determined that the temperature is previously controlled (Step S101: YES), the CPU 110 reads a target temperature table from the memory 111 to set CHn of the TEC_B 123b (Step S102). For example, the CPU 110 reads the target temperature table illustrated in FIG. 6.

Next, the CPU 110 specifies a target temperature of the TEC_B 123b (Step S103). For example, the CPU 110 refers to the target temperature table illustrated in FIG. 6 and specifies the “array chip 2” that is the even-numbered array chip 121 arranged on the waiting-side TEC_B 123b and outputs the optical signal having the desired wavelength “λ5”. Moreover, the CPU 110 specifies the target temperature “T′5” stored in association with the wavelength “λ5” of the “array chip 2” from the target temperature table.

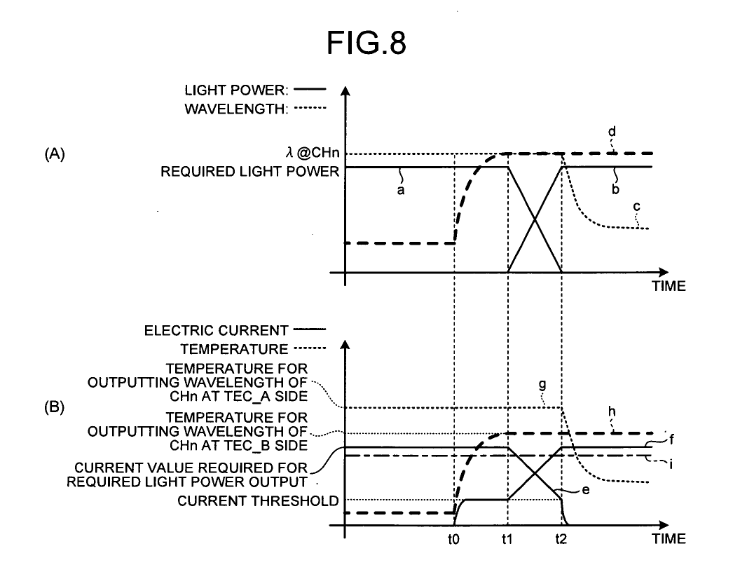

Then, the CPU 110 starts the temperature control of the TEC_B 123b in accordance with the target temperature specified at Step S103 (Step S104). In this case, because the temperature control performed by the CPU 110 is a feedback control, it is below referred to as a “temperature control loop”. For example, the CPU 110 starts the control of the TEC_B driver 116b in such a manner that the temperature of the TEC_B 123b becomes the target temperature “T′5”. This corresponds to a time “t0” of FIG. 8.

When it is determined that the temperature of the TEC_B 123b is not previously controlled at Step S101 (Step S101: NO) or after the temperature control of the TEC_B 123b is started at Step S104, the optical transmission device 100 enters a normal operation state.

During a normal operation, the CPU 110 appropriately determines whether the temperature of the laser diode module 120 is in a normal range (Step S105). Moreover, in the second embodiment, the CPU 110 does not determine whether the temperature is in the range of the requirement specification of the laser diode module 120, in other words, within the range from “T_{LD}max” to “T_{LD}min” but determines whether the temperature is within the range of from “T_{LD}maxWN” to “T_{LD}minWN” of the warning step.

Because the temperature of the laser diode module 120 is in a normal range when it is determined that the temperature is within the range from “T_{LD}maxWN” to “T_{LD}minWN” of the warning step (Step S105: YES), the CPU 110 continues to perform the determination at Step S105.

On the other hand, when it is determined that the temperature is not in the range from “T_{LD}maxWN” to “T_{LD}minWN” of the warning step (Step S105: NO), the CPU 110 determines whether the temperature of the waiting-side TEC_B 123b has been previously controlled for CHn (Step S106).

When it is determined that the temperature has been previously controlled (Step S106: YES), the CPU 110 promptly switches its operation from the operating-side TEC_A 123a to the waiting-side TEC_B 123b (Step S107). In other words, the CPU 110 switches from the LD driver A 112a to the LD driver B 112b when the temperature of the waiting-side TEC_B 123b has been previously controlled to “T′5”. Moreover, this corresponds to a time “t1” of FIG. 8.

Then, the CPU 110 terminates the temperature control loop of the TEC_A 123a that was an operating-side (Step S108). Moreover, this corresponds to a time “t2” of FIG. 8.

On the other hand, when it is determined that the temperature is not previously controlled at Step S106 (Step S106: NO), the CPU 110 reads a target temperature table from the memory 111 to set CHn of the TEC_B 123b (Step S109). For example, the CPU 110 reads the target temperature table illustrated in FIG. 6.

Next, the CPU 110 specifies the target temperature of the TEC_B 123b (Step S110). For example, the CPU 110 refers to the target temperature table illustrated in FIG. 6 and specifies the “array chip 2” that is the even-numbered array chip 121 arranged on the waiting-side TEC_B 123b and outputs the optical signal having the desired wavelength “λ5”. Moreover, the CPU 110 specifies the target temperature “T′5” stored in association with the wavelength “λ5” of the “array chip 2” from the target temperature table.

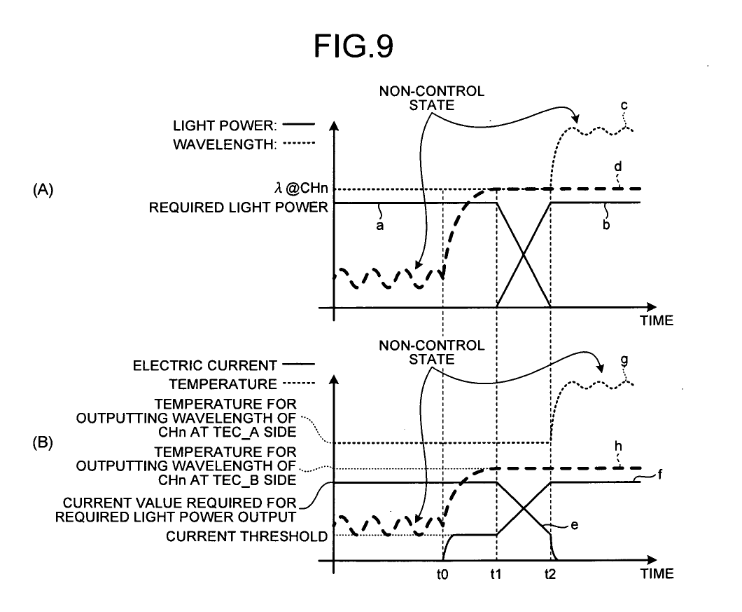

Then, the CPU 110 starts the temperature control of the TEC_B 123b in accordance with the target temperature specified at Step S110 (Step S111). For example, the CPU 110 starts controlling the TEC_B driver 116b in such a manner that the temperature of the TEC_B 123b becomes the target temperature “T′5”. Moreover, this corresponds to a time of “t0” illustrated in FIG. 9.

Next, the CPU 110 determines whether the temperature of the laser diode module 120 is stable or not (Step S112). For example, the CPU 110 determines whether the temperature is within the range from “T−α” to “T+α” that is obtained by subtracting and adding an error α from and to the target temperature T. When it is determined that the temperature is not stable (Step S112: NO), the CPU 110 repeats the determination until the temperature is stable. Moreover, because the “array chip 2” that was a waiting side is not degraded at this step, it is assumed that it is in the state where the “array chip 2” outputs the optical signal having the desired wavelength “λ5” when the temperature of the TEC_B 123b is stable before or after the target temperature T.

On the other hand, when it is determined that the temperature is stable (Step S112: YES), the CPU 110 switches its operation from the operating-side TEC_A 123a to the waiting-side TEC_B 123b (Step S113). In other words, the CPU 110 switches from the LD driver A 112a to the LD driver B 112b. Moreover, this corresponds to a time “t1” illustrated in FIG. 9.

Then, the CPU 110 terminates the temperature control loop of the TEC_A 123a that was an operating side (Step S114). Moreover, this corresponds to a time “t2” illustrated in FIG. 9.

Next, it will be in detail explained about a temperature control during switching the array chip 121 with reference to FIGS. 8 and 9. FIGS. 8 and 9 are diagrams explaining a temperature control during switching the array chip 121.

First, FIG. 8 corresponds to the case where previously controlling a temperature is selected at Step S101 of FIG. 7. In (A) of FIG. 8, a horizontal axis indicates a time and a vertical axis indicates a desired wavelength (λ@CHn (wavelength λ at CHn)) and light power required to output an optical signal having the desired wavelength.

A symbol “a” (solid line) indicates the light power of the optical signal output from the TEC_A 123a and a symbol “b” (solid line) indicates the light power of the optical signal output from the TEC_B 123b. As will be appreciated from the comparison of the line of the symbol “a” and the line of the symbol “b”, the light power of the optical signal output from the TEC_A 123a stepwise and gradually decreases after the time “t1” (corresponding to Step S107 of FIG. 7). Then, the light power becomes “0” at the time “t2” (corresponding to Step S108 of FIG. 7). On the other hand, the light power of the optical signal output from the TEC_B 123b stepwise and gradually increases after the time “t1” (corresponding to Step S107 of FIG. 7) and becomes the requested light power at the time “t2” (corresponding to Step S108 of FIG. 7).

Moreover, a symbol “c” (dotted line) indicates the wavelength of the optical signal output from the TEC_A 123a and a symbol “d” (thick dotted line) indicates the wavelength of the optical signal output from the TEC_B 123b. As will be appreciated from the comparison of the line of the symbol “c” and the line of the symbol “d”, the wavelength of the optical signal output from the TEC_A 123a is changed from the desired wavelength “λ5” after the time “t2” (corresponding to Step S108 of FIG. 7). On the other hand, the wavelength of the optical signal output from the TEC_B 123b is gradually changed after the time “t0” (corresponding to Step S104 of FIG. 7) and becomes the desired wavelength “λ5” at the time “t1” (corresponding to Step S107 of FIG. 7).

Next, in (B) of FIG. 8, a horizontal axis indicates a time and a vertical axis indicates a target temperature for outputting an optical signal having a desired wavelength on the TEC_A 123a and a target temperature for outputting an optical signal having a desired wavelength on the TEC_B 123b. Furthermore, the vertical axis indicates a current value and a current threshold required for light power required to output an optical signal having a desired wavelength. In this case, a current threshold is a value around which “light power is output when exceeding itself”. For convenience of explanation, in (B) of FIG. 8, it has been illustrated about the case where the TEC_A 123a and the TEC_B 123b have the same current threshold. However, the present invention is not limited to this. Because the TEC_A 123a and the TEC_B 123b include the array chips 121 different from each other, they may strictly have different current thresholds.

A symbol “e” (solid line) indicates an electric current input into the TEC_A 123a from the LD driver A 112a and a symbol “f” (solid line) indicates an electric current input into the TEC_B 123b from the LD driver B 112b. As will be appreciated from the comparison of the line of the symbol “e” and the line of the symbol “f”, an electric current input into the TEC_A 123a stepwise begins to decrease after the time “t1” (corresponding to Step S107 of FIG. 7) and becomes “0” when passing the time “t2” (corresponding to Step S108 of FIG. 7). On the other hand, an electric current input into the TEC_B 123b gradually begins to increase from the time “t0” (corresponding to Step S104 of FIG. 7) and becomes a current threshold up to the time “t1” (corresponding to Step S107 of FIG. 7). Then, the electric current stepwise increases between from the time “t1” (corresponding to Step S107 of FIG. 7) to the time “t2” (corresponding to Step S108 of FIG. 7) to become a current value required to output the requested light power.

Moreover, a symbol “g” (dotted line) indicates the temperature of the TEC_A 123a and a symbol “h” (thick dotted line) indicates the temperature of the TEC_B 123b. As will be appreciated from the comparison of the line of the symbol “g” and the line of the symbol “h”, the temperature of the TEC_A 123a firstly starts to decrease from the temperature for outputting the optical signal having the desired wavelength “λ5” at the time “t2” (corresponding to Step S108 of FIG. 7). On the other hand, the temperature of the TEC_B 123b gradually rises from the time “t0” (corresponding to Step S104 of FIG. 7) and arrives at the temperature for outputting the optical signal having the desired wavelength “λ5” at the time “t1” (corresponding to Step S107 of FIG. 7).

Moreover, a symbol “i” (broken line) indicates the temperature of the TEC_C 123c that is arranged on the central part 125a. As described above, the central part 125a according to the second embodiment is arranged on the TEC_C 123c in such a manner that its temperature is controlled independently of the TEC_A 123a and the TEC_B 123b. For this reason, as illustrated in FIG. 8, the temperature of the TEC_C 123c arranged on the central part 125a is constantly retained irrespective of the temperatures of the TEC_A 123a and the TEC_B 123b.

For convenience of explanation, it has been illustrated about the state prior to the time “t0” in FIG. 8. Because previously controlling a temperature is selected, there is not actually the state prior to the time “t0” in the operation.

Next, FIG. 9 corresponds to the case where previously controlling a temperature is not selected at Step S101 of FIG. 7. In (A) of FIG. 9, a horizontal axis indicates a time and a vertical axis indicates a desired wavelength (λ@CHn) and light power required to output an optical signal having the desired wavelength.

A symbol “a” (solid line) indicates the light power of the optical signal output from the TEC_A 123a and a symbol “b” (solid line) indicates the light power of the optical signal output from the TEC_B 123b. As will be appreciated from the comparison of the line of the symbol “a” and the line of the symbol “b”, the light power of the optical signal output from the TEC_A 123a stepwise and gradually decreases after the time “t1” (corresponding to Step 5113 of FIG. 7). Then, the light power becomes “0” at the time “t2” (corresponding to Step S114 of FIG. 7). On the other hand, the light power of the optical signal output from the TEC_B 123b stepwise and gradually begins to increase after time the “t1” (corresponding to Step S113 of FIG. 7) and becomes the requested light power at the time “t2” (corresponding to Step S114 of FIG. 7).

Moreover, a symbol “c” (dotted line) indicates the wavelength of the optical signal output from the TEC_A 123a and a symbol “d” (thick dotted line) indicates the wavelength of the optical signal output from the TEC_B 123b. As will be appreciated from the comparison of the line of the symbol “c” and the line of the symbol “d”, the wavelength of the optical signal output from the TEC_A 123a becomes a non-control state from the desired wavelength “λ5” after the time “t2” (corresponding to Step S114 of FIG. 7). On the other hand, the wavelength of the optical signal output from the TEC_B 123b is gradually changed after the time “t0” (corresponding to Step S111 of FIG. 7) from the non-control state and becomes the desired wavelength “λ5” at the time “t1” (corresponding to Step S113 of FIG. 7).

In (B) of FIG. 9, a horizontal axis indicates a time and a vertical axis indicates a target temperature for outputting an optical signal having a desired wavelength on the TEC_A 123a and a target temperature for outputting an optical signal having a desired wavelength on the TEC_B 123b. Furthermore, the vertical axis indicates a current value and a current threshold required for light power required to output an optical signal having a desired wavelength. For convenience of explanation, it has been illustrated about the case where the TEC_A 123a and the TEC_B 123b have the same current threshold in (B) of FIG. 9. However, the present invention is not limited to this. Because the TEC_A 123a and the TEC_B 123b have the array chips 121 different from each other, they may strictly have different current thresholds.

A symbol “e” (solid line) indicates an electric current input into the TEC_A 123a from the LD driver A 112a and a symbol “f” (solid line) indicates an electric current input into the TEC_B 123b from the LD driver B 112b. As will be appreciated from the comparison of the line of the symbol “e” and the line of the symbol “f”, an electric current input into the TEC_A 123a begins to decrease after the time “t1” (corresponding to Step S113 of FIG. 7) and becomes “0” when passing the time “t2” (corresponding to Step S114 of FIG. 7). On the other hand, an electric current input into the TEC_B 123b gradually begins to increase from time “t0” (corresponding to Step S111 of FIG. 7) and becomes a current threshold up to the time “t1” (corresponding to Step S113 of FIG. 7). Then, the electric current stepwise increases between from the time “t1” (corresponding to Step S113 of FIG. 7) to the time “t2” (corresponding to Step S114 of FIG. 7) and becomes a current value required to output the requested light power.

Moreover, a symbol “g” (dotted line) indicates the temperature of the TEC_A 123a and a symbol “h” (thick dotted line) indicates the temperature of the TEC_B 123b. As will be appreciated from the comparison of the line of the symbol “g” and the line of the symbol “h”, the temperature of the TEC_A 123a firstly becomes a non-control state from the temperature for outputting the optical signal having the desired wavelength “λ5” at the time “t2” (corresponding to Step S114 of FIG. 7). On the other hand, the temperature of the TEC_B 123b gradually rises from the non-control state when it is the time “t0” (corresponding to Step S111 of FIG. 7) and arrives at the temperature for outputting the optical signal having the desired wavelength “λ5” at the time “t1” (corresponding to Step S113 of FIG. 7).

### Effect of Second Embodiment

As described above, the optical transmission device 100 according to the second embodiment includes the array chips 121 arranged on the TEC_A 123a and the array chips 121 arranged on the TEC_B 123b. Moreover, because the temperatures of the TEC_A 123a and the TEC_B 123b are independently controlled, the temperature of the array chips 121 arranged on the TEC_A 123a is controlled independently of the temperature of the array chips 121 arranged on the TEC_B 123b. Under such a configuration, the optical transmission device 100 detects the generation of a failure from the array chip 121 that is arranged on the operating-side TEC. Then, when the generation of a failure is detected, the optical transmission device 100 switches its operation into the array chip 121 that is arranged on the waiting-side TEC and outputs the optical signal having the same wavelength as that of the optical signal of the array chip 121 in operation.

In this way, according to the second embodiment, the temperature of the array chips 121 selected as an operating side is controlled independently of the temperature of the waiting-side array chips 121. For this reason, when the array chip 121 in operation has a failure, the array chip 121 in operation can be smoothly switched into the waiting-side array chip 121 that is independently controlled to a temperature corresponding to a desired wavelength and thus a conventional restart is unnecessary. As a result, the operation is continuously performed and the loss of data can be prevented. Moreover, because the laser diode module should not be wholly exchanged when one of the array chips 121 has a failure, the lifetime of the laser diode module 120 can be improved.

Moreover, according to the second embodiment, the central part 125a is arranged on the TEC_C 123c and its temperature is controlled independently of the TEC_A 123a and the TEC_B 123b. Because of this, according to the second embodiment, the central part 125a can constantly retain its temperature irrespective of the temperatures of the TEC_A 123a and the TEC_B 123b, and thus temperature compensation should not be performed on the information that is acquired by the central part 125a and is fed back to the CPU 110.

Moreover, according to the second embodiment, when the array chip 121 is switched, the CPU 110 stepwise decreases the light power output of the array chip 121 in operation and stepwise increases the light power output of the array chip 121 that is a switching destination. When a light power output is switched temporarily by instantaneously switching an electric current, the light power output of the array chip 121 is the sum of the light powers that are output from the TEC_A 123a and the TEC_B 123b. Therefore, when the switching is asynchronously performed minutely, light power outputs have a difference and thus there is a possibility that the temperature of the TEC_B 123b exceeds the range that is prescribed as the requirement specification. On the contrary, according to the second embodiment, because the switching is stepwise performed, there is not a possibility that the difference is caused.

### [c] Third Embodiment

Next, it will be explained about the optical transmission device 100 according to the third embodiment. In the optical transmission device 100 according to the second embodiment, the central part 125a is arranged on the TEC_C 123c in such a manner that its temperature is controlled independently of the TEC_A 123a and the TEC_B 123b. On the contrary, the optical transmission device 100 according to the third embodiment has a configuration that the central part 125a is influenced by the temperatures of the TEC_A 123a and the TEC_B 123b.

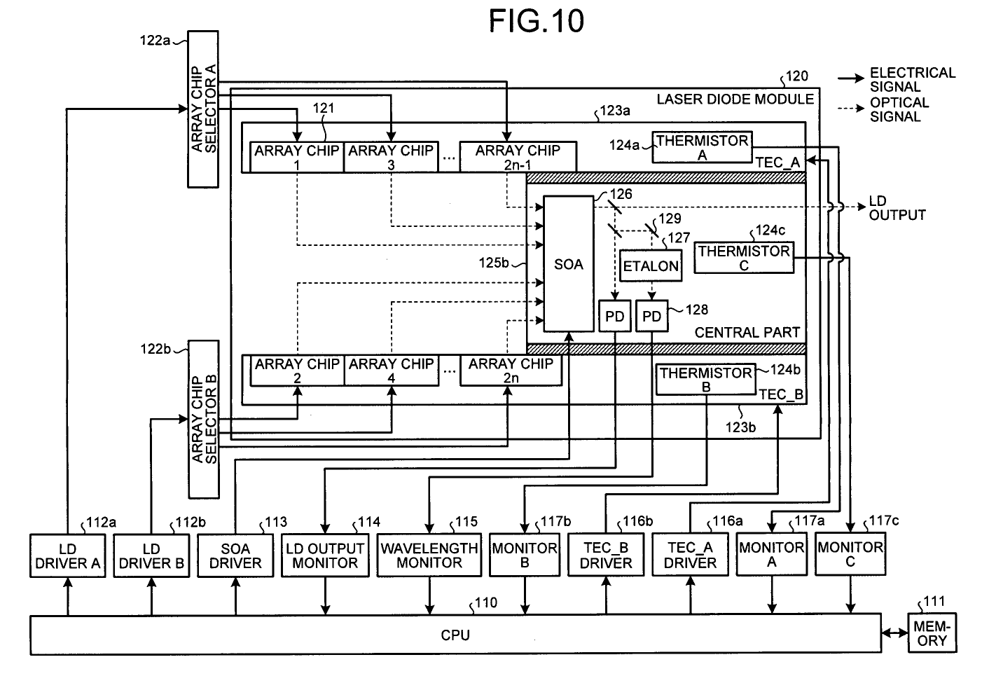

FIG. 10 is a block diagram illustrating the configuration of the laser diode module 120 according to the third embodiment. As illustrated in FIG. 10, a central part 125b according to the third embodiment is not arranged on the TEC_C 123c and includes a member (hatched part) having small thermal resistance between itself and each of the TEC_A 123a and the TEC_B 123b. Moreover, the present invention is not limited to the configuration illustrated in FIG. 10. The present invention may have another configuration that the central part 125a is influenced by the temperatures of the TEC_A 123a and the TEC_B 123b.

In such a configuration, the CPU 110 according to the third embodiment controls the temperature of the central part 125b by controlling the temperature of a waiting-side TEC. For example, the CPU 110 receives the temperature information of the central part 125b measured by the thermistor C 124c via the monitor C 117c and controls the temperature of the central part 125b by feedback-controlling the temperature of the waiting-side TEC_B 123b.

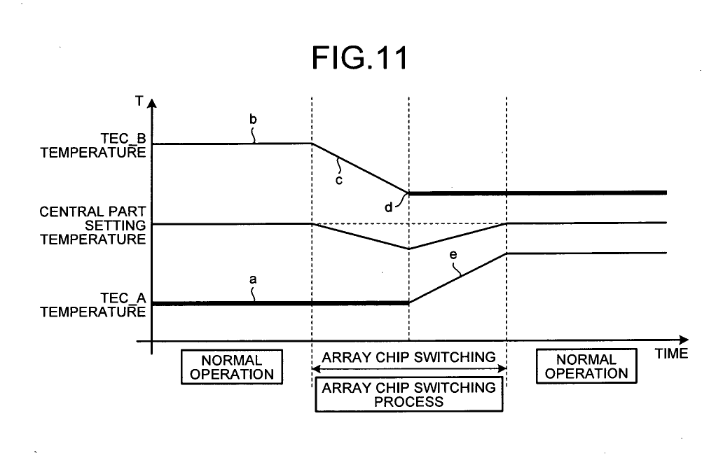

FIG. 11 is a diagram explaining the temperature control of the central part during switching the array chip 121. In FIG. 11, a horizontal axis indicates a time and a vertical axis indicates a temperature. Moreover, three lines illustrated in FIG. 11 are a line indicating the temperature of the waiting-side TEC_B 123b, a line indicating the temperature of the central part 125b, and a line indicating the temperature of the operating-side TEC_A 123a in sequence from top. Moreover, thick-line portions indicate an operational state. Hereinafter, it will be explained about the case where switching is performed in a state where the array chip 121 that can easily output an optical signal having a desired wavelength is uniquely specified and thus the TEC_A 123a becomes an operating side and the TEC_B 123b becomes a waiting side.

A portion illustrated with a symbol “a” is a thick line and indicates that the TEC_A 123a is in an operational state. On the other hand, when the temperature of the waiting-side TEC_B 123b is a symbol “b”, the temperature of the central part 125b is controlled to around an intermediate value between the temperature of the waiting-side TEC_B 123b and the temperatures of the TEC_A 123a, as illustrated in FIG. 11. In this case, considering that the TEC_A 123a is an operating side, the temperature of the TEC_A 123a is expected to be a temperature corresponding to a desired wavelength. Therefore, when the temperature of the central part 125b is set, the temperature of the central part 125b is controlled to a setting temperature by controlling the temperature of the waiting-side TEC_B 123b.

As illustrated in FIG. 11, when entering the switching process of the array chip 121, the temperature of the waiting-side TEC_B 123b is gradually changed in such a manner that the waiting-side TEC_B 123b is switched into an operating side and becomes a temperature corresponding to a desired wavelength as indicated by a symbol “c”. Then, the temperature of the waiting-side TEC_B 123b becomes a temperature corresponding to the desired wavelength at a switching time indicated by a symbol “d”.

On the other hand, the temperature of the operating-side TEC_A 123a is expected to still correspond to the desired wavelength up to the switching time indicated by the symbol “d”. For this reason, as illustrated in FIG. 11, the temperature of the central part 125b is slightly deviated from the setting temperature. However, after passing the switching time indicated by the symbol “d”, the temperature of the TEC_B 123b is expected to be the temperature corresponding to the desired wavelength and the temperature of the TEC_A 123a may be an arbitrary temperature. For this reason, as indicated by a symbol “e”, the temperature of the central part 125b is controlled to the setting temperature by controlling the temperature of the TEC_A 123a.

As described above, the temperature of the central part 125b is slightly deviated from the setting temperature in the switching process. For this reason, the optical transmission device 100 according to the third embodiment stores a temperature compensation table in the memory 111. In other words, the memory 111 stores temperature compensation information in the temperature compensation table. The temperature compensation information indicates how much correction is to be made on light power output information and wavelength information which are fed back to the CPU 110, when the temperature of the central part 125b is shifted from the setting temperature by a certain degree. Then, in the switching process, the CPU 110 refers to the temperature compensation table of the memory 111 by using the temperature information of the central part 125b and corrects the light power output information and wavelength information that are fed back from the LD output monitor 114 and the wavelength monitor 115. Moreover, the CPU 110 performs a feedback control on the basis of information after correction.

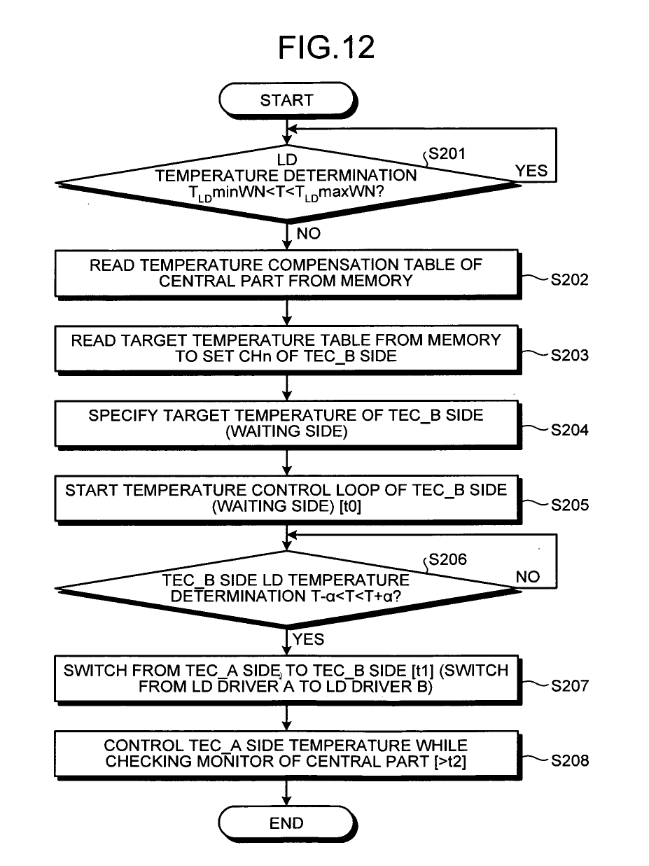

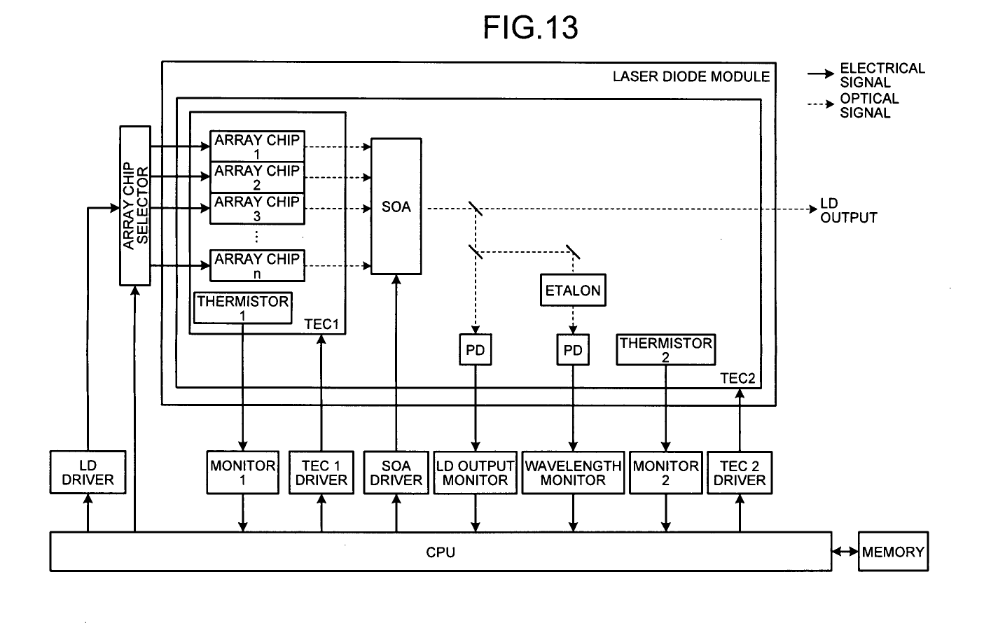

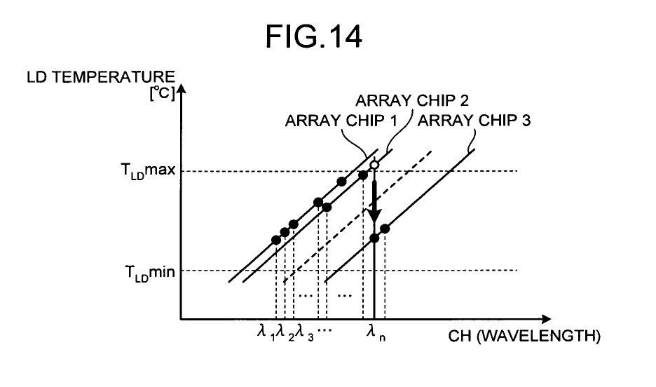

Next, it will be explained about a temperature control according to the third embodiment with reference to FIG. 12. FIG. 12 is a diagram explaining a temperature control according to the third embodiment. During a normal operation, the CPU 110 appropriately determines whether the temperature of the laser diode module 120 is in a normal range (Step S201). In the third embodiment, the CPU 110 does not determine whether the temperature is in the range of the requirement specification of the laser diode module 120, in other words, the range from “T_{LD}max” to “T_{LD}min” but determines whether the temperature is in the range from “T_{LD}maxWN” to “T_{LD}minWN” of the warning step.

When it is determined that the temperature is not in the range from “T_{LD}maxWN” to “T_{LD}minWN” of the warning step (Step S201: NO), the CPU 110 reads the temperature compensation table of the central part 125b from the memory 111 (Step S202).

Next, the CPU 110 reads the target temperature table from the memory 111 to set CHn of the TEC_B 123b (Step S203). For example, the CPU 110 reads the target temperature table illustrated in FIG. 6.

Next, the CPU 110 specifies a target temperature of the TEC_B 123b (Step S204). For example, the CPU 110 refers to the target temperature table illustrated in FIG. 6 and specifies the “array chip 2” that is the even-numbered array chip 121 arranged on the waiting-side TEC_B 123b and outputs the optical signal having the desired wavelength “λ5”. Moreover, the CPU 110 specifies the target temperature “T′5” stored in association with the wavelength “λ5” of the “array chip 2” from the target temperature table.

Then, the CPU 110 starts the temperature control of the TEC_B_123b in accordance with the target temperature specified at Step S204 (Step S205). For example, the CPU 110 starts the control of the TEC_B driver 116b in such a manner that the temperature of the TEC_B 123b becomes the target temperature “T′5”. Moreover, this corresponds to the time of “t0” illustrated in FIG. 9.

Next, the CPU 110 determines whether the temperature of the laser diode module 120 is stable or not (Step S206). For example, the CPU 110 determines whether the temperature is in the range from “T−α” to “T+α” that is obtained by subtracting and adding an error α from and to the target temperature T. When it is determined that the temperature is not stable (Step S206: NO), the CPU 110 repeats the determination until the temperature is stable. In this case, because the “array chip 2” that was a waiting side is not degraded at this step, it is assumed that it is in the state where the “array chip 2” outputs the optical signal having the desired wavelength “λ5” when the temperature of the TEC_B 123b is stable before or after the target temperature T.

On the other hand, when it is determined that the temperature is stable (Step S206: YES), the CPU 110 switches its operation from the operating-side TEC_A 123a to the waiting-side TEC_B 123b (Step S207). In other words, the CPU 110 switches from the LD driver A 112a to the LD driver B 112b. Moreover, this corresponds to the time “t1” illustrated in FIG. 9.

Then, the CPU 110 terminates the temperature control loop of the TEC_A 123a that was an operating side (Step S208). Moreover, this corresponds to the time “t2” illustrated in FIG. 9.

### Effect of Third Embodiment

As described above, according to the third embodiment, the temperature of the central part 125b is controlled by the TEC that becomes a waiting side. Moreover, the optical transmission device 100 according to the third embodiment stores the temperature compensation table that stores correction information for correcting the information acquired by the central part 125b in association with each difference with the setting temperature of the central part 125b for each the difference. Moreover, when the central part 125b is not maintained to the setting temperature in the switching process, the CPU 110 determines a difference between the setting temperature and the temperature of the central part 125b and refers to the temperature compensation table by using the determined difference. Then, the CPU 110 corrects a feedback control by using the correction information stored in association with the difference. Because of this, according to the third embodiment, the temperature of the central part 125b can be constantly retained by using two TECs in a conventional manner without providing TEC for the central part 125b.

### [d] Fourth Embodiment

Next, it will be explained about the optical transmission device 100 according to the fourth embodiment. In the optical transmission device 100 according to the second and third embodiments, the central parts 125a and 125b have a setting temperature. However, in the optical transmission device 100 according to the fourth embodiment, a central part does not have a setting temperature.

Specifically, the optical transmission device 100 according to the fourth embodiment stores a temperature compensation table in the memory 111. In other words, the memory 111 stores temperature compensation information in the temperature compensation table. The temperature compensation information indicates how much correction is to be made on light power output information and wavelength information which are fed back to the CPU 110, when the temperature of the central part 125b is shifted from the setting temperature by a certain degree. Then, even in a normal operation in addition to the switching process, the CPU 110 refers to the temperature compensation table of the memory 111 by using the temperature information of the central part and corrects the light power output information and wavelength information that are fed back from the LD output monitor 114 and the wavelength monitor 115. Moreover, the CPU 110 performs a feedback control on the basis of information after correction.

### Effect of Fourth Embodiment

As described above, according to the fourth embodiment, the temperature of the central part is not controlled. Moreover, the optical transmission device 100 according to the fourth embodiment stores the temperature compensating table that stores correction information for correcting the information acquired by the central part in association with each difference with the setting temperature of the central part for each the difference. Moreover, the CPU 110 determines a difference between the setting temperature and the temperature of the central part and refers to the temperature compensating table by using the determined difference. Then, the CPU 110 corrects a feedback control by using the correction information stored in association with the difference.

Because of this, according to the fourth embodiment, it is not necessary to provide TEC for the central part and to further perform a temperature control by using the TEC that becomes a waiting side. For this reason, the TEC that becomes a waiting side can be previously controlled to a temperature corresponding to a desired wavelength. In other words, the TEC can be previously controlled to the target temperature of the same wavelength of the array chips 121 to be replaced when it is detected that the operating-side array chip 121 has a failure, and thus the switching of the array chip 121 can be performed in a short time.

### [e] Fifth Embodiment

As above, it has been explained about the first to fourth embodiments. These embodiments are only an exemplification. Therefore, the optical transmission device disclosed in the present application can be realized by other configurations that are made by performing various modifications and improvements on the optical transmission device.

For example, according to the embodiments, it has been explained about a technique for using TEC as a technique for adjusting the temperature of an array chip. However, the optical transmission device disclosed in the present application is not limited to this. Another component may be used in place of TEC if the component can adjust the temperature of an array chip.

As described above, according to an aspect of the present invention, it is possible to prevent the loss of data.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An optical transmission device comprising:
a first optical output unit that includes a chip and outputs an optical signal having a predetermined wavelength according to a temperature;
a second optical output unit that includes a chip of which a temperature is controlled independently of the chip of the first optical output unit and outputs an optical signal having a predetermined wavelength according to a temperature;
a failure detecting unit to detect a generation of a failure from the chip in operation of the first optical output unit;
a switching unit to switch its operation to the chip of the second optical output unit that outputs an optical signal having a same wavelength as that of the optical signal of the chip in operation when the generation of the failure is detected by the failure detecting unit; and
a transmitting unit to transmit the optical signal output from the chip of the second optical output unit by switching the operation by the switching unit.

2. The optical transmission device according to claim 1, further comprising
an information acquiring unit configured to be maintained to a predetermined temperature and acquires information on the optical signal output from the first optical output unit or the second optical output unit; and
a feedback control unit to feedback-control the first optical output unit or the second optical output unit based on the information acquired by the information acquiring unit, wherein
the information acquiring unit is maintained to the predetermined temperature via temperature control independent from the first optical output unit and the second optical output unit.

3. The optical transmission device according to claim 1, further comprising
an information acquiring unit configured to be maintained to a predetermined temperature and acquires information on the optical signal output from the first optical output unit or the second optical output unit;
a feedback control unit to feedback-control the first optical output unit or the second optical output unit based on the information acquired by the information acquiring unit; and
a correction information storage unit to store correction information for correcting the information acquired by the information acquiring unit in association with each difference with the predetermined temperature, wherein
the information acquiring unit is maintained to the predetermined temperature by temperature control by the second optical output unit before the switching performed by the switching unit and is maintained to the predetermined temperature by temperature control by the first optical output unit after the switching performed by the switching unit, and
the feedback control unit determines a difference between the predetermined temperature and a temperature of the information acquiring unit, refers to the correction information storage unit by using the determined difference, and corrects the feedback control by using the correction information stored in association with the difference when the information acquiring unit is not maintained to the predetermined temperature in the switching process performed by the switching unit.

4. The optical transmission device according to claim 1, further comprising
an information acquiring unit to acquire information on the optical signal output from the first optical output unit or the second optical output unit;
a feedback control unit to feedback-control the first optical output unit or the second optical output unit based on the information acquired by the information acquiring unit; and
a correction information storage unit to store a temperature of the information acquiring unit and correction information for correcting the information acquired by the information acquiring unit in association with each other,
the feedback control unit determines a difference between the predetermined temperature and the temperature of the information acquiring unit, refers to the correction information storage unit by using the determined difference, and corrects the feedback control by using the correction information stored in association with the difference.

5. The optical transmission device according to claim 1, wherein the switching unit stepwise decreases a light power output of the first optical output unit and stepwise increases a light power output of the second optical output unit when its operation is switched to the chip of the second optical output unit.

6. The optical transmission device according to claim 1, wherein the failure detecting unit detects the generation of the failure when a temperature of the chip is higher than a first temperature that is a predetermined temperature lower than a maximum temperature permitted for the first optical output unit and when the temperature of the chip is lower than a second temperature that is a predetermined temperature higher than a minimum temperature permitted for the first optical output unit.

7. The optical transmission device according to claim 1, wherein
each of the first optical output unit and the second optical output unit includes a plurality of chips of which each has one or a plurality of operating points for outputting an optical signal having a predetermined wavelength, and all the wavelengths within a predetermined range is covered by the plurality of chips of the first optical output unit and the second optical output unit, and
set wavelengths of the optical signals for the chips of the first optical output unit partially overlap with set wavelengths of the optical signals for the chips of the second optical output unit, respectively.
